(19) United States
(12) Patent Application Publication
(10) Pub. No.: US 2010/0327615 A1
(43) Pub. Date: Dec. 30, 2010

(54) TEXTILE SLING AND METHOD OF MANUFACTURING SAME

(75) Inventors: Bosch Juan Ponsa, Guangdong Province (CN); Argemi Juan Ponsa, Guangdong Province (CN)

Correspondence Address: Dongguan Ponsa Textile Limited, TIANZHAI, YISHA VILLAGE, SHATIAN TOWN, DONGGUAN CITY, GUANGDONG PROVINCE, CN

(73) Assignee: Dongguan Ponsa Textile Limited, Guangdong Province (CN)

(21) Appl. No.: 12/821,122

(22) Filed: Jun. 22, 2010

(30) Foreign Application Priority Data
Jun. 24, 2009 (ES) P200930352

(51) Int. Cl. B66C 1/12; D03D 41/00; D06B 1/00

(52) U.S. Cl. 294/74; 139/11; 28/167

(57) ABSTRACT

A textile sling (10) of the present invention includes a fabric webbing body (1) and reinforced side or sides (2) engaged with the webbing body. The reinforced side or sides are woven to selvedges of the own webbing body from anti abrasion yarns, thus a high protection is obtained to the selvedges of the sling from wearing down. On a surface and around yarns of the sling forms an antiabrasive layer (3) made from polyurethane dispersion with a catalyst solution of modified aliphatic polyisocyanate. A method of manufacturing the textile sling is also disclosed. The final sling product presents greater cut and abrasion resistance.

### BACKGROUND OF THE INVENTION

The present invention relates to general safety equipments for lifting, sling, tie down, or lashing straps, tapes, or lanyards for any use, and especially to a cut and abrasion resistant sling and method of manufacturing the same.

Sling is widely used as general safety equipment for lifting, tie down, or lashing. Industrial applications refers to any where involved a lifting, pulling or towing, and includes as well those for transportation applications such as Vessels, ship Carriers, ro-ro vessels, military vessels or ships, planes commercial carriers or military carriers, Trucks, Cars, SUV (sport utility vehicle), motorbikes or any other possible, for industrial, commercial, military or aerospace applications.

For instance, a lifting sling, including round sling, endless sling, one way sling, webbing sling, tubular slings, eye to eye slings, double band sling, single band sling, flat sling, tree trunk sling or any other type of sling, is widely used for lifting, pulling or towing of heavy weight goods for industrial, commercial, military and aerospace applications.

For tie down and lashing strap applications, the sling is also used as ratchet tie down in any form, cam buckle tie down in any form, winch tie down in any form, truck lashings in any form, car lashing in any form, lashing tapes in any form, lashing webbings in any form or any other type of lashing system that might be able to use this type of lashing tie down webbing or tape.

However, the sling will be subjected to cut or abrasion during normal operation, which brings damage to the sling, and will cause catastrophic failure during use.

It is very important and there is a long felt need to increase the anti cut and abrasion of the sling. Actually the existing technology uses sleeve or jacket protection on the webbings of products such as lifting, sling, tie down or lashing lanyard, to protect them from abrasion or cut. For example, U.S. Pat. No. 4,886,691 shows a cut resistant article, which comprises a cut resistant jacket surrounding a less cut resistant member. The jacket comprises a fabric of yarn, and the yarn consisted of a high strength, longitudinal strand wrapped with another fiber or the same fiber. Other conventional sleeve or jacket is also made in rubber, plastic, or textile clothes. Sleeve is attached over the final product and fixed using a stitching machine, mould forming, or the like, thus covering the sling with a tubular or round sleeve. However, the existing technology is not cost effective since it requires various additional steps and materials, and the reliability and effectiveness of anti cut is in a low profile. Furthermore, it is very easy to unbound and not precisely positioned, what could possibly cause the looseness of tension and the loss of the cargo during transportation applications or for lifting applications manipulating the cargo, if sleeve is not perfectly positioned.

Other conventional method to improve the cut and abrasion resistance of the webbing, as shown in U.S. Pat. No. 5,419,951, provided a protective warp yarn structure made up of bicomponent fibers. The bicomponent fibers include a polyester core with a sheath of a polymer with a lower melting point than the polyester. Herein the webbing has been subjected to a heat treatment sufficient to cause melting of said sheath, but not of the core. However, it is not always effective to improve the cut and abrasion resistance using such modified warp yarns to weave into the webbing. Furthermore, it is a costly and complex process to obtain the bicomponent fibers.

Therefore, an improved sling and a method of manufacturing the same is desired which overcomes the disadvantages of the prior art.

### BRIEF SUMMARY OF THE INVENTION

A main object of the present invention is to provide a textile sling, which can become very tough to abrasion and cut, improve the life cycle 2-10 times, and supply a much safer use.

A further object of the present invention is to provide a method of manufacturing the textile sling, which is more effective and reliable, simpler, and cost-effective.

To obtain the above object, a textile sling comprises a fabric webbing body and reinforced side or sides. The reinforced side or sides are engaged with the webbing body. Wherein the reinforced side or sides are woven to selvedges of the own webbing body from anti abrasion yarns, thereby a high protection is obtained to the selvedges of the sling from wearing down. Preferably, on a surface and around yarns of the sling forms an antiabrasive layer made from polyurethane dispersion with a catalyst solution of modified aliphatic polyisocyanate. Therefore, an anti-cut and antiabrasive textile sling is obtained.

A method of manufacturing a textile sling comprises steps of:

(1) weaving fabric to obtain webbing body, and weaving anti abrasion fiber to obtain reinforced side or sides in accordance with selvedges of the own webbing body, therefore, high protection to the wearing down of these selvedges is obtained;
(2) applying surface finish to the webbing body using a polyurethane dispersion with a catalyst solution of modified aliphatic polyisocyanate; and
(3) drying the webbing body thus obtaining antiabrasive textile sling with an antiabrasive layer being formed on the surface and around yarns thereof.

Other objects, advantages and novel features of the invention will become more apparent from the following detailed description of a preferred embodiment thereof when taken in conjunction with the accompanying drawings, wherein:

### BRIEF DESCRIPTION OF THE DRAWINGS

FIG. 1 is a plan schematic view of part of endless sling in accordance with an embodiment of the present invention;

FIG. 2 is a schematic view of woven structure of the sling in FIG. 1;

FIG. 3 is a perspective view of an eye to eye sling with an embodiment of the present invention; and

FIG. 4 is a perspective view of a sling incorporating individual metallic terminals with an embodiment of the present invention.

### DETAILED DESCRIPTION OF THE INVENTION

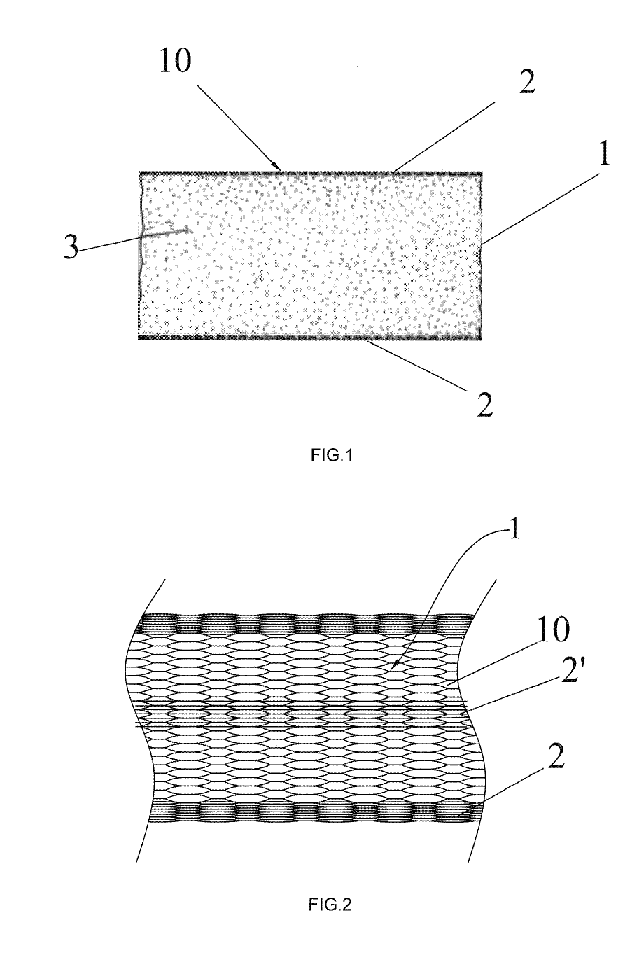

As shown in FIGS. 1 and 2, textile sling 10 in accordance with an embodiment of the present invention, comprises a webbing body 1 and reinforced side or sides 2. The reinforced sides 2 are engaged with the webbing body 1 in correspondence with selvedges thereof.

The webbing body 1 generally is an elongated flexible band, strip, strap, lanyard or tape of woven textile material. Textile materials for the webbing body 1 can be chosen from: high tenacity synthetic polyester, polypropylene, Nylon or polyamides, polyethylene high modulus, Kevlar, ballistic nylon, ballistic PES (Polyethersulfone), ballistic polypropylene, or other synthetic fiber in the art, with one or more combined together. It is preferred that the webbing is manufactured using fiber chosen from high tenacity yarns, such as polyester, polypropylene, Nylons or polyamides, Kevlar and polyethylene high Modulus yarns. The webbing body 1 is braided, knitted, or woven from the previous fibers with weaving looms or the like.

The reinforced sides 2 are made from anti abrasion yarns. The anti abrasion yarns include high tenacity or normal tenacity synthetic yarns, like ballistic polyesters, nylons, polypropylenes, Kevlar, carbon fiber, PE high modulus yarns, silicone threads, or any other the market could offer.

During the own process of weaving fabric of the webbing body 1, in correspondence with the songs or selvedges thereof, anti abrasion fibers for reinforced sides 2 are incorporated jointly in the weaving looms together with the weaving fabric, so that the webbing body 1 is woven up with the reinforced sides 2 being woven to either side thereof. High resistance to confer to webbing body 1, and therefore to the sling 10 that it is obtained, a high protection to the wearing down of these songs or selvedges. It is understood that if desired, the anti abrasion fiber can also be woven to the webbing body 1 along longitudinal yarns thereof to form reinforced strands 2′ as shown in FIG. 2, which can increases anti cut and abrasion of the sling 10, too.

The sling 10 of the present invention, as shown in FIG. 1, forms an anti-abrasion layer 3 around the yards and over the surface of both the webbing body 1 and the reinforced sides 2. Herein the anti-abrasion layer 3 is preferably made from polyurethane dispersion with a catalyst solution of modified aliphatic polyisocyanate, or other resin that might be in the market.

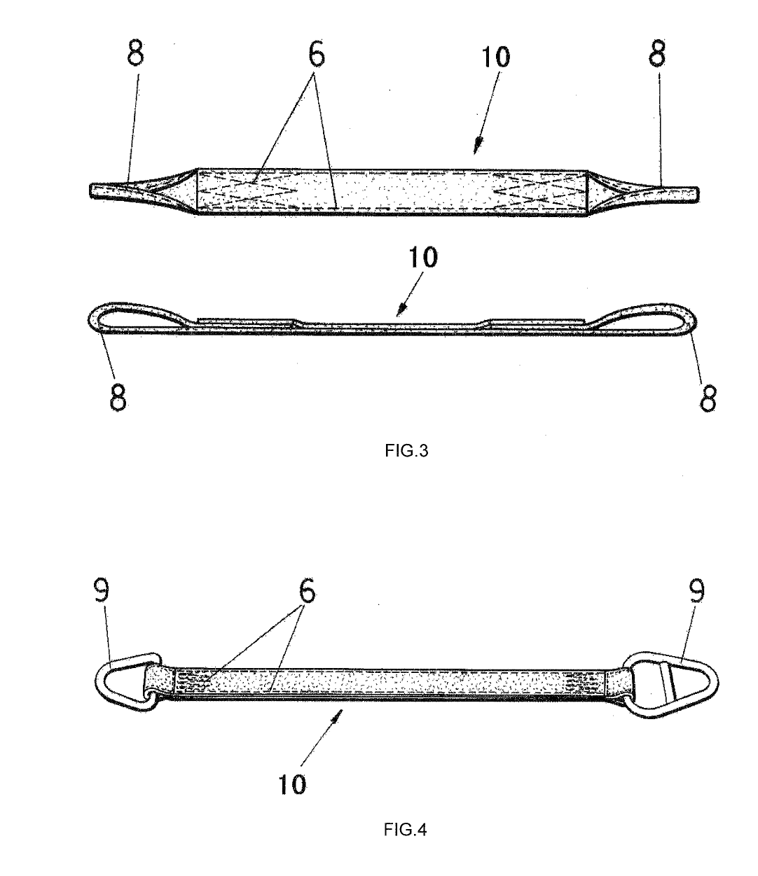

FIGS. 3 and 4 shows a kind of sling 10 in use. The endless sling 10 in FIGS. 1 and 2 is cut to the wished length, twisted back at two ends to forms eyelets 8 with pertinent sewing 6 taking place thereon. FIG. 4 shows the sling 10 is incorporated with metallic terminals 9. Any other attachments made from any possible material like plastic or metal, such as buckles, winch, hooks, rings or any other rigging component, can be incorporated with the sling 10 according to different operation requirements.

It is understood that the sling 10 of the present invention, can further comprises a cut and abrasion resistant protection (not shown) thereon, wherein the cut and abrasion resistant protection is made from an anti-cut and anti-abrasion chemically composed paste of a plastisol mixture, such as vinyl plastisol and acrylic plastisol. Furthermore, a thin webbing interlayer (not shown) may be inserted between the webbing body 1 and the cut and abrasion resistant protection in another embodiment. The interlayer may be a woven strap, band, or tape, and may also be a non-woven strap or sheet. Materials for the interlayer may be chosen from high tenacity synthetic polyester, polypropylene, Nylon or polyamides, polyethylene high modulus, Kevlar, ballistic nylon, ballistic PES, ballistic polypropylene, UHMWPE (Dyneema), or other synthetic fiber in the art, with one or more combined together. The interlayer can also be made from various materials in the art in order to reinforce the webbing.

A method of manufacturing the textile sling 10 in the present invention comprises steps of:

(1) weaving fabric to obtain the webbing body 1, and weaving anti-abrasion fiber to obtain the reinforced side or sides 2 to songs or selvedges of the own webbing body 1, therefore, high protection to the wearing down of these songs or selvedges is obtained;
(2) applying surface finish to the webbing body 1 using a polyurethane dispersion with a catalyst solution of modified aliphatic polyisocyanate;
(3) predrying and further drying the webbing body 1 thus obtaining antiabrasive textile sling 10 with the antiabrasive layer 3 being formed on the surface and around yarns thereof; and
(4) post processing for preparing different kinds of sling 10 by cutting with the wished length, sewing the ends, or incorporating attachments thereto.

Wherein, the method as described above, between step (2) and (3), may further comprises a step of: coating the webbing body 1 with the plastisol paste, such as vinyl plastisol or acrylic plastisol, to form cut and abrasion resistant protection on the surface of the webbing body 1.

According to another embodiment of the present invention, the method comprises a further step: before being coated the cut and abrasion resistant protection onto the surface of the webbing body 1, but inserting another thin webbing interlayer therebetween.

At the step (1), not only being woven in accordance with selvedges of the own webbing body 1 in order to form reinforced side/sides 2, the anti abrasion fiber can also be woven along longitudinal yarns to the webbing body 1 to form reinforced strands 2′ if desired.

At the step (2), the webbing body 1 is impregnated in a polyurethane dispersion with a catalyst solution of modified aliphatic polyisocyanate, thus the surface and yarns of both the webbing body 1 and the reinforced sides 2 are coated with the polyurethane dispersion. Herein, with regard to the solution formula, it varies depending on what type of surface finish for the sling 10 in use, more resistance less water and more chemical. In a preferable embodiment, in the water solution, concentration of polyurethane is at a range of 5-40% by weight and catalyst at a range of 1-20% by weight. For instance, chemical solution, polyurethane is at 25%, catalyst at 5%, and the residual, water at 70%. Other finishing types, different solution quantities are applied: like polyutherane at 30%, catalyst at 10%, and water at 60%, and other possibles, like polyutherane 15%, catalyst 5% and water 80%.

At the step (3), the process of predrying and drying is not particularly limited. The temperature for predrying and drying is adjusted to 90 to 300 degrees Celsius. The predrying and drying processes preferably take place at 230 degree Celsius for 3 minutes. Therefore, the antiabrasive layer 3 is cured on the surface and around thread of yarns of the textile sling 10.

According to different operation, all kinds of sling 10 can be obtained through post processing, such as cutting to different length or size, sewing, incorporating different attachments thereto, or the like. Such sling 10 is shown in FIGS. 3 and 4 as examples.

The final sling product, being manufactured according to the above method, becomes very tough to abrasion and cut in use. More detailed, the reinforced side or sides 2 impart the sling 10 high protection to the songs or selvedges thereof from wearing down. The reinforced strands 2′ can confer to the sling 10 greater cut and abrasive resistance. Moreover, in the process of surface finish, not only the surface of the sling 10, but also the yarns of both the webbing body 1 and the reinforced sides 2 or the reinforced strands 2′, are wet or socked with polyurethane dispersion, thus each yarns are well wrapped with antiabrasive layer and tightly bonded together after drying. Therefore, not only the surface of the webbing body, but also each thread of yarns tightly forms an antiabrasive layer therearound, and tightly bonding together. Additionally, another protection layer can be formed on the surface of the sling 10, or even a reinforced interlayer inserted therebetween, the anti cut and abrasion of the sling 10 will be further enhanced.

What is claimed is:

1. A textile sling comprising
a fabric webbing body; and
reinforced side or sides engaged with the webbing body;
wherein the reinforced side or sides are woven to the own webbing in accordance with selvedges thereof from anti abrasion yarns, thereby a high protection is obtained to the selvedges of the sling from wearing down.

2. The textile sling according to claim 1, wherein on a surface and around yarns of the sling forms an antiabrasive layer thereon.

3. The textile sling according to claim 2, wherein said antiabrasive layer is made from polyurethane dispersion with a catalyst solution of modified aliphatic polyisocyanate.

4. The textile sling according to claim 1, wherein the anti abrasion yarns for the reinforced side or sides are chosen from polyesters, nylons, polypropylenes, Kevlar, carbon fiber, PE high modulus yarns, or silicone threads.

5. The textile sling according to claim 4, wherein a reinforced strands is configured along longitudinal yarns of the webbing body by weaving the anti abrasion yarns.

6. The textile sling according to claim 1, further comprises a cut and abrasion resistant protection made from an anti cut and anti abrasion chemically composed paste of a plastisol mixture over the webbing body.

7. The textile sling according to claim 6, further comprises a thin webbing interlayer being inserted between the webbing body and the cut and abrasion resistant protection.

8. The textile sling according to claim 7, wherein said thin webbing interlayer is a fabric woven or a non-woven strap or sheet.

9. A method of manufacturing a textile sling comprising steps of:
(1) weaving fabric to obtain webbing body, and weaving anti abrasion fiber to obtain reinforced side or sides in accordance with selvedges of the own webbing body, therefore, high protection to these selvedges from wearing down being obtained;
(2) applying surface finish to the webbing body using a polyurethane dispersion with a catalyst solution of modified aliphatic polyisocyanate; and
(3) drying the webbing body thus obtaining antiabrasive textile sling with an antiabrasive layer being formed on the surface and around yarns thereof.

10. The method according to claim 9, wherein at the step (2), the polyurethane dispersion comprises polyurethane at a range of 5-40% by weight and catalyst at a range of 1-20% by weight.

11. The method according to claim 10, wherein at the step (2), the polyurethane dispersion comprises polyurethane 25%, catalyst 5%, and water 70% all by weight.

12. The method according to claim 10, wherein at the step (2), the polyurethane dispersion comprises polyurethane 30%, catalyst 10%, and water 60% all by weight.

13. The method according to claim 10, wherein at the step (2), the polyurethane dispersion comprises polyurethane 15%, catalyst 5%, and water 80% all by weight.

14. The method according to claim 9, wherein at the step (3), drying process takes place at 90 to 300 degrees Celsius.

15. The method according to claim 11, wherein at the step (3), drying process takes place at 230 degree Celsius for 3 minutes.
